(19) United States
(12) Patent Application Publication
(10) Pub. No.: US 2013/0016098 A1
(43) Pub. Date: Jan. 17, 2013

(54) Method for creating a 3-dimensional model from a 2-dimensional source image

(71) Applicant: Jamie Addessi, Burlington, VT (US)

(72) Inventor: Jamie Addessi, Burlington, VT (US)

(73) Assignee: RASTER LABS, INC., Burlington, VT (US)

(21) Appl. No.: 13/184,547

(22) Filed: Jul. 17, 2011

(51) Int. Cl. G06T 17/00

(52) U.S. Cl. 345/420

(57) ABSTRACT

A method is disclosed which allows the user of a software program to create a 3-dimensional model from a 2-dimensional source image. The method includes: providing a 3-dimensional environment to contain the model, placing the 2-dimensional source image within the environment as a layer, providing tools for the user to extract portions of the image onto additional layers, providing tools for the user to change the depth of vertices within the layers.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to the field of modeling 3D objects within a computer and more particularly to a method for creating a 3D model of a photographed scene which may provide a realistic representation of that scene when viewed from a wide range of viewing positions within the 3D environment.

Computer software is widely available which is capable of providing 3D environments. This includes desktop software such as OpenGL, as well as web-based software such as WebGL, Papervision, Away3D, Molehill, and many others.

A 3D model is a mathematical representation of 3D surfaces within a 3D environment which can be visually displayed using 3D rendering techniques. A 3D model may also be used in a computer simulation of physical phenomena or it may be physically created using 3D Printing devices.

Technology is rapidly advancing in the field of 3D graphics software and hardware, but there is still a shortage of quality 3D content. A great deal of content exists in 2D image form, but there is no tool available which facilitates the creation of a realistic 3D model from a single 2D source image.

Many computer programs are available which allow users to create arbitrary 3D models, primarily used by designers to create 3D models of original objects with the intention of constructing these objects in the real world or placing them in virtual environments like video games. These programs are devoid of functionality specialized for the creation of a realistic 3D model representation of a scene which was originally photographed.

Methods have been developed to create a 3D model from multiple 2D source images. These methods rely on computerized analysis of the differences between the provided images to generate depth information. Unfortunately, these methods require multiple 2D source images, and are not applicable in the many cases where only a single 2D source image is available. Some examples of these methods are detailed in U.S. Pat. Nos. 5,633,995, 7,889,196, 7,636,088, 7,394,977, 7,206,000, 7,015,926 and US Patent Applications 20110157159, 20110090318, 20110025829, and 20100215240.

Algorithms have been developed which enable a computer to automatically generate a 3D model from a single 2D source image, relying on statistical processes which analyze patterns in the source image. These algorithms yield 3D models which are not realistic in most cases, due to the fact that computers have great difficulty recognizing objects in images and great difficulty determining the depth of independent objects in a scene. It is for these reasons that more realistic 3D models are created when incorporating human users into the process rather than just computers. Some examples of automated methods are detailed in US Patent Applications 20110090216, 20110080400, 20100266198, and 20100085358.

Methods have been developed to create a stereoscopic pair from a 2D source image. These methods create a 2D complimentary image from the 2D source image by repositioning pixels on the horizontal X-axis of the complimentary image. The combination of 2D source image and 2D complimentary image, called a stereoscopic pair, can be viewed by different eyes resulting in a 3D viewing experience. However, a stereoscopic pair is a substantially different result than a 3D model, and the methods used to create each are substantially different. Some examples of methods which can create stereoscopic pairs are detailed in U.S. Pat. Nos. 7,116,323, 6,686,926, and 6,208,348, 7,876,321, and US Patent Application 20070279415.

### BRIEF SUMMARY OF THE INVENTION

The invention provides a method which enables a user to create a 3D model from an existing 2D source image. The user is provided with tools to identify objects and to add depth and structure to the 3D model within the 3D environment, while ensuring geometric consistency between the 3D model and the 2D source image. The 3D model may look identical to the 2D source image when viewed from one specific position within the 3D environment, but it will also provide a realistic representation of the scene when viewed from an wide range of other viewing positions within the 3D environment.

### BRIEF DESCRIPTION OF THE SEVERAL VIEWS OF THE DRAWING

In the drawings:

FIG. 1 is a flow chart showing a process for creating a 3D model from a 2D source image in accordance with the present invention;

FIG. 2 shows an example 2D source image;

FIG. 3 shows a visual representation of a 3D environment containing a single background layer;

FIG. 4 shows an example of an additional layer which was created using extraction tools;

FIG. 5 shows an example of a previously existing layer which was affected by extraction tools;

FIG. 6 shows a visual representation of a 3D environment after the push/pull tool was used;

FIG. 7 shows a visual representation of a 3D environment before and after the axis pivot tool was used;

FIG. 8 shows a visual representation of a 3D environment before and after the bend tool was used;

FIG. 9 shows a visual representation of a 3D environment before and after the stretch tool was used;

FIG. 10 shows the geometry which is used to calculate the camera origin;

FIG. 11 shows the geometry which is used to determine the scaling rates of x values;

FIG. 12 shows the geometry which is used to determine the scaling rates of y values;

FIG. 13 shows a visual representation of a 3D environment in which x and y positions of vertices have been scaled to ensure geometric consistency between the 3D model and the 2D source image;

### DETAILED DESCRIPTION OF THE INVENTION

In the current embodiment, the 3D environment is provided using the web-based Adobe Flash 3D framework. Continuous surfaces, called layers, may be placed within the 3D environment. Each layer comprises a multitude of vertex points (vertices), the corresponding vertex positions within the 3D environment, and a texture mapping which specifies planar regions of pixels to be drawn onto the layer between the vertices. Each vertex has a position specified by an x, y, and z value. The z value is also referred to as the depth. Layers often contain hundreds of vertices which are spaced at regular intervals in a grid-like manner. Although the regions drawn between the vertices are planar, a large number of closely spaced vertices can create the illusion of smooth curvature across a layer with depth variation.

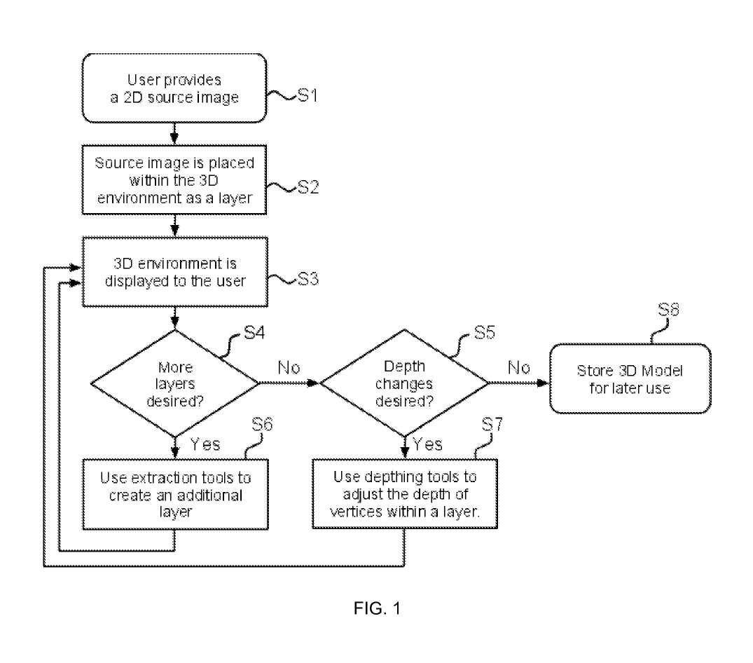

Referring to the flow chart shown in FIG. 1, a process for creating a 3D model from a 2D source image will be described.

At Step S1, a 2D source image is provided by the user. The user may either upload an image file, specify a web URL of an image file, or select from a provided list of sample image files.

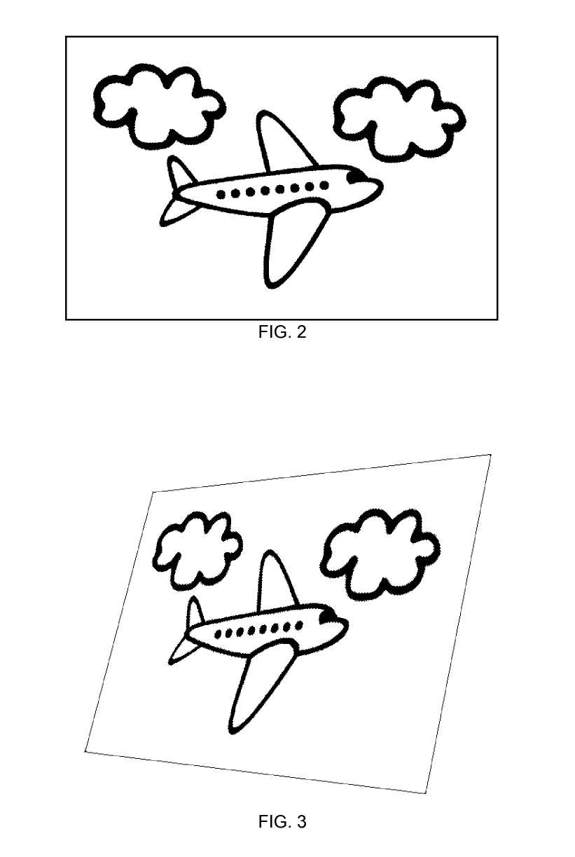

FIG. 2 shows an example 2D source image.

At Step S2, the source image is placed within the 3D environment as a layer, referred to as the background layer. The depth of all vertices in the background layer are initialized to zero, and the positions of each of the vertices on this layer are considered the original positions of the vertices.

At Step S3, the 3D environment is visually displayed to the user with 3D rendering techniques provided by the Adobe Flash 3D framework. The user is able to view the environment from virtual camera positions, and controls are provided which enable the user to rotate, pan, and zoom the camera if desired.

FIG. 3 shows a visual representation of the 3D environment after the background layer has been created.

At Steps S4 and S5, the user may choose to use the extraction tools or to use the depthing tools. The extraction tools may be used if the user wishes to add additional layers to the 3D model, and the depthing tools may be used if the user wishes to change the depth of vertices within any of the existing layers. The user may use the extraction tools and depthing tools as many times as desired and in any order desired.

At Step S6, the user may use the extraction tools to create an additional layer. The extraction tools are described in more detail below.

At Step S7, the user may use the depthing tools to adjust the depth of vertices within an existing layer. The depthing tools are described in more detail below.

At Step S8, the user has finished creating their 3D model, and they may store it for later use. The storing process is described below.

Extraction Tools

Extraction tools enable the user to extract particular regions of existing layers onto additional layers. The purpose of creating additional layers is to enable the user to subsequently change the depth of vertices within each of the layers independently.

The user might choose to extract the region of the background layer which represents the airplane onto an additional layer. In the present embodiment, the user uses a pointing device such as a computer mouse to move a circular virtual paint brush over the airplane and to apply paint color to a designated region. An eraser tool may also be used to undesignate portions of the region in a similar manner. The paint is only temporarily applied for the purpose of designating the region, and the pixel colors within that region are immediately restored afterwards.

In another embodiment, object recognition techniques may be used to aid the user in selecting a region. Numerous techniques exist in the field of computer vision which attempt to locate objects in an image. Although this task is still a challenge for computer vision systems in general, applying even a rudimentary object recognition algorithm may provide some level of benefit to the user. For example, rather than simply applying paint color to a selected region, the software could analyze the pixels surrounding the region and extend the selection through pixels that fall within a certain range of color similarity to the pixels in the selected region, the extent of that range determined with the mouse scroll wheel. For certain types of images, this method could expedite the process and increase the accuracy of the region selection process.

Once the user has satisfactorily covered the airplane, they may choose to extract the layer. The pixels from the selected region are removed from the existing layer and copied into the texture for the new layer. Any pixels within the layer that are not part of the designated region are made transparent, creating the illusion that the layer only exists in the designated region.

It is not necessary for the user to specify a region which exactly aligns with pixels in the airplane image. A realistic representation may be achieved with just a reasonably accurate covering of the airplane. In addition, the software may apply some gradual transparency around the edges of the region in the extracted layer to soften the edges.

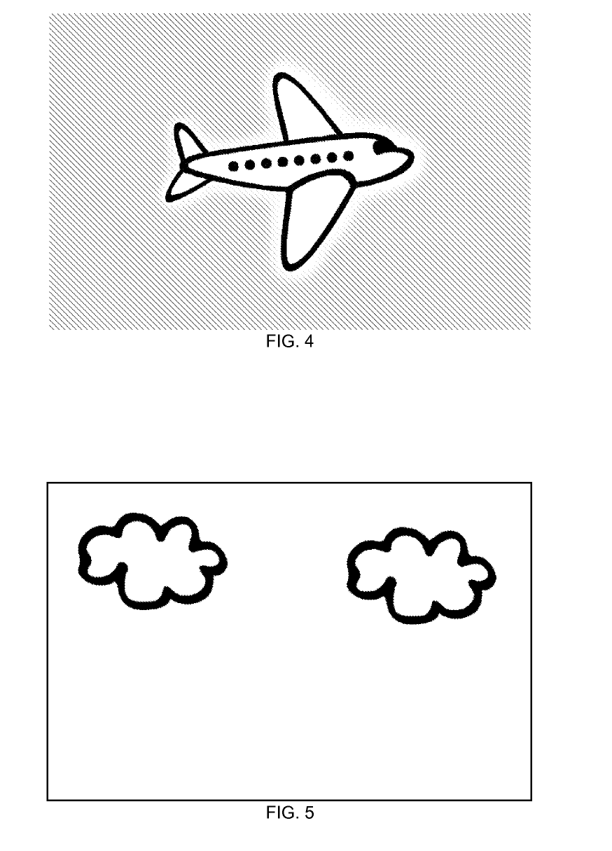

FIG. 4 shows an example of the additional layer which was created using the extraction tools. The diagonal lines are used to indicate areas of transparency in this layer.

The new layer is positioned within the 3D environment in a manner such that all pixels in the new layer have the same positions that they had in the previously existing layer. The software may automatically adjust the depth of vertices in the newly created layer immediately after its creation so that the new layer appears visually separate from the previously existing layer, assuming this automatic depth adjustment would be subject to the geometric consistency requirements described below.

The software will need to fill in the area where the extracted region of pixels was removed from the previously existing layer. One strategy is to fill the area with transparency, but in most cases it is more desirable to fill in the area with a pattern generated based on the pixel colors of the region adjacent to the extraction region. In the example provided, the region is filled with a white sky pattern to smoothly align with the white sky pixels in the surrounding region.

A variety of algorithms exist in the field of Photo Manipulation which may be used to generate a fill pattern based on the pixel colors of an adjacent region. This process is often referred to as inpainting or image interpolation. In the present embodiment, an algorithm was implemented which tiles and blurs pixels near the edge of the region repeatedly, until the area where the extracted region of pixels was removed is entirely filled in.

FIG. 5 shows the previously existing layer as it results after the extraction tools were utilized as described.

Of course, a fill pattern may not accurately represent what existed in the real world since there is no way to automatically determine what was actually present in an obscured space. However, inpainting techniques have been determined to provide a reasonable level of authenticity, especially since the area being filled is not the primary subject matter of the 3D model. Good inpainting techniques will lead to more realistic 3D models.

The term realistic as used herein indicates that the overall experience when interacting with the 3D model will create a general sense of authenticity and consistency with the original photographed scene. Even if careful scrutiny of certain areas of the model are not convincing, the effect of the overall 3D model will be realistic.

In a different embodiment, the user may achieve a greater level of authenticity by importing a specification of replacement pixels from another program which provides specialized image editing functionality.

Depthing Tools

Depthing tools allow the user to change the depth of vertices within the layers. In the present embodiment, the user uses a pointing device such as a computer mouse to access 4 depthing tools including push/pull, axis pivot, bend, and stretch. Each of the depthing tools allow the user to control the magnitude of the depth changes by moving the mouse up or down while holding the mouse button. As the mouse moves, the software repeatedly calculates the distance that the mouse has moved, which is the user-specified delta value. The mouse position on the layer when depthing starts is considered the depthing position.

The push/pull tool allows the user to increase or decrease the depth of all vertices within a specified layer. The user may position the mouse over the desired layer and move it up or down while holding the mouse button. As the mouse moves, the depth of each of the vertices in the layer is increased or decreased by the delta value.

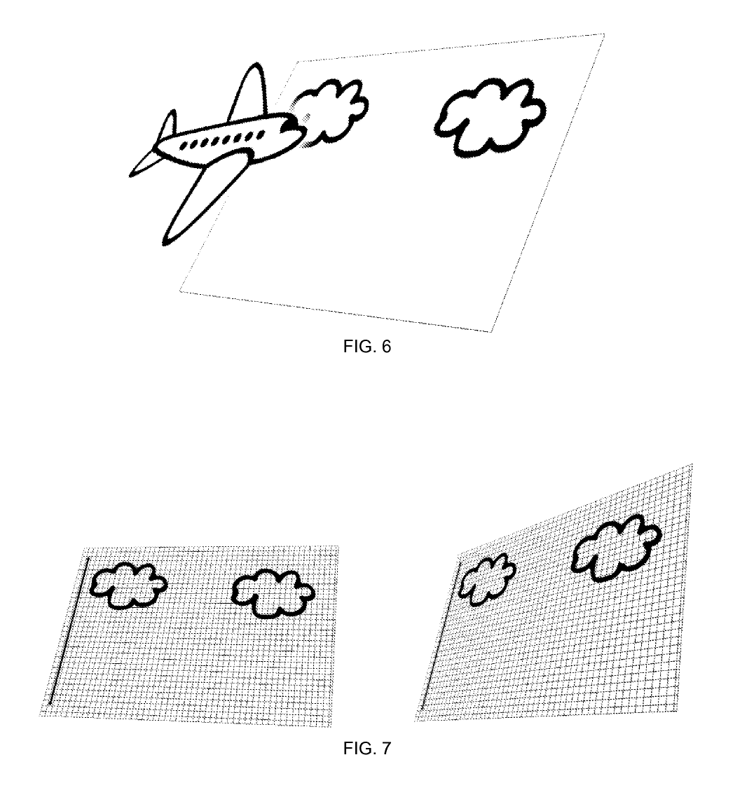

FIG. 6 shows a visual representation of the 3D environment after the push/pull tool was used to move the airplane layer forward.

The axis pivot tool allows the user to change the depth of one or more vertices in a layer by different amounts, calculated based on their positions relative to a line. The user may click on the layer in 2 places to create 2 pivot points. Pivot points effectively lock the layer in place at their positions. The pivot line is the line which connects the points and extends beyond them indefinitely. The user may then position the mouse over the desired layer and move it up or down while holding the mouse button. As the mouse moves, the depth of each of the vertices in the layer is increased or decreased by an amount proportional to its distance from the pivot line and also proportional to the delta value. Vertices on opposite sides of the pivot line move in opposite directions.

The equation used to calculate resulting depth values for the axis pivot tool is:

adjusted z=original z+delta z*dist/max

dist=the distance from the vertex to the pivot line

max=the distance from the depthing position to the pivot line

FIG. 7 shows a visual representation of the 3D environment before and after the axis pivot tool was used on the background layer. A grid has been drawn onto the layer to illustrate the depth changes. The dark line which runs down the left side of the layer is the pivot line, which connects the 2 pivot points placed by the user.

The bend tool allows the user to change the depth of one or more vertices in a layer by different amounts, calculated based on their positions relative to a triangle. The user may click on the layer in 3 places to create 3 pivot points. The user may then position the mouse over the desired layer and move it up or down while holding the mouse button. 2 of the 3 pivot points are automatically chosen based on their proximity to the depthing position, and the pivot line is the line which connects these 2 pivot points. As the mouse moves, the depth of one or more vertices in the layer is increased or decreased by an amount proportional to its distance from the pivot line and also proportional to the delta value. Only vertices which are on the same side of the pivot line as the depthing position are modified, creating the result of bending.

The equation used to calculate resulting depth values for the bending tool is:

adjusted z=original z+delta z*dist/max

dist=the distance from the vertex to the pivot line

max=the distance from the depthing position to the pivot line

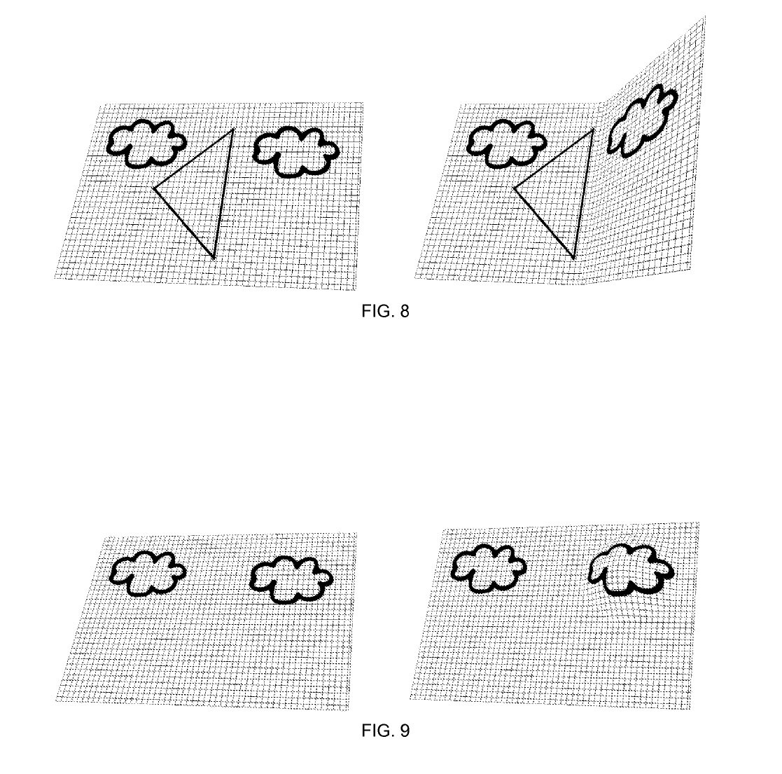

FIG. 8 shows a visual representation of the 3D environment before and after the bend tool was used on the background layer. A grid has been drawn onto the layer to illustrate the depth changes. The triangle formed by the 3 dark lines in the middle of the layer is the pivot line, which connects the 3 pivot points placed by the user. In this example, the pivot line is the rightmost line of the triangle, and only vertices on the right side of the pivot line are subject to modification.

The stretch tool allows the user to change the depth of one or more vertices in a layer by different amounts, calculated based on their positions relative to a user-specified stretch brush. The user may select from a multitude of available stretch brushes which are simply geometric shapes of various dimensions including circle, oval, and ellipse.

The user may position the stretch brush over a specific region of the desired layer using the mouse, and move the mouse up or down while holding the mouse button. As the mouse moves, the depth of one or more vertices in the layer is increased or decreased by an amount based partially on its location within the depth brush and also proportional to the delta value. Only vertices which are inside the depth brush are modified, creating the result of stretching.

The equation used to calculate resulting depth values for the stretch tool is:

adjusted z=original z+delta z*(1−√(1−dist²/max²))

dist=the distance from the vertex to the boundary of the stretch brush

max=the greatest distance from any point inside the stretch brush to its boundary

FIG. 9 shows a visual representation of the 3D environment before and after the stretch tool was used on the background layer. A grid has been drawn onto the layer to illustrate the depth changes. In this example, a circular stretch brush was used on the area surrounding the right cloud, resulting in a rounded surface which resembles a hemisphere.

Geometric Consistency

In order to achieve a realistic representation of the original photographed scene, it is desirable that vertices within the layers maintain geometric consistency between the 3D model and the 2D source image. A 3D model can be considered geometrically consistent with a 2D source image if it appears identical to the 2D source image when viewed from a particular position using 3D rendering techniques.

To ensure this consistency, the process of depthing allows the user to adjust vertices in the forward and backward directions, but not in the left, right, up, or down directions. Each of the depthing tools described allow the user to change the depth of vertices within the layers. These tools do not allow the user to directly modify the x or y positions of the vertices.

In one embodiment, the x and y positions of vertices are never changed after their initial creation. When layers are extracted, each of the pixels on the extracted layer maintain the same x and y values which the same pixels had in the previously existing layer. This method ensures geometric consistency since the 3D model will appear identical to the 2D source image when viewed from many positions on the z axis using orthagonal projection 3D rendering techniques. This method may achieve a somewhat realistic representation of the original photographed scene in some cases, but often the scaling of objects will be noticeably incorrect since objects in images appear larger when they are closer to the camera. Returning to FIG. 6, it is clear that the 3D model shown was created in this manner because the airplane layer retains it's original size even though the depth of its vertices have been changed.

In the present embodiment, the x and y positions of a vertex are scaled by an amount proportional to the amount that the vertex depth was changed from its initial depth. This is equivalent to making layers proportionally smaller as their depth is moved forward and proportionally larger as their depth is moved backward.

The camera origin is the point within the 3D environment where the camera was assumed to have taken the photograph. The field of view angle is the angle formed between the camera origin and the vertical boundaries of the background layer.

The user is provided the ability to specify the field of view angle, which effectively determines the position of the camera origin based on the following relationship:

camera origin=background layer height/(2*tan(field of view angle))

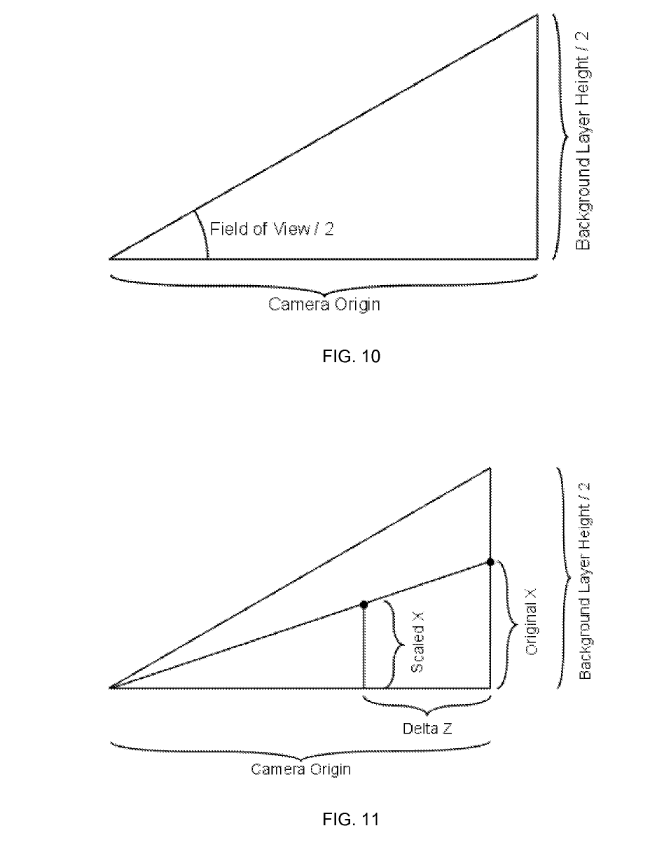

FIG. 10 shows the geometry used to calculate the camera origin.

When a change of depth is required for a vertex, the x and y values of that vertex are automatically scaled by the following equations:

scaled x=original x*(camera origin−delta z)/camera origin;

scaled y=original y*(camera origin−delta z)/camera origin;

FIG. 11 shows the geometry which is used to determine the scaling rates of x values.

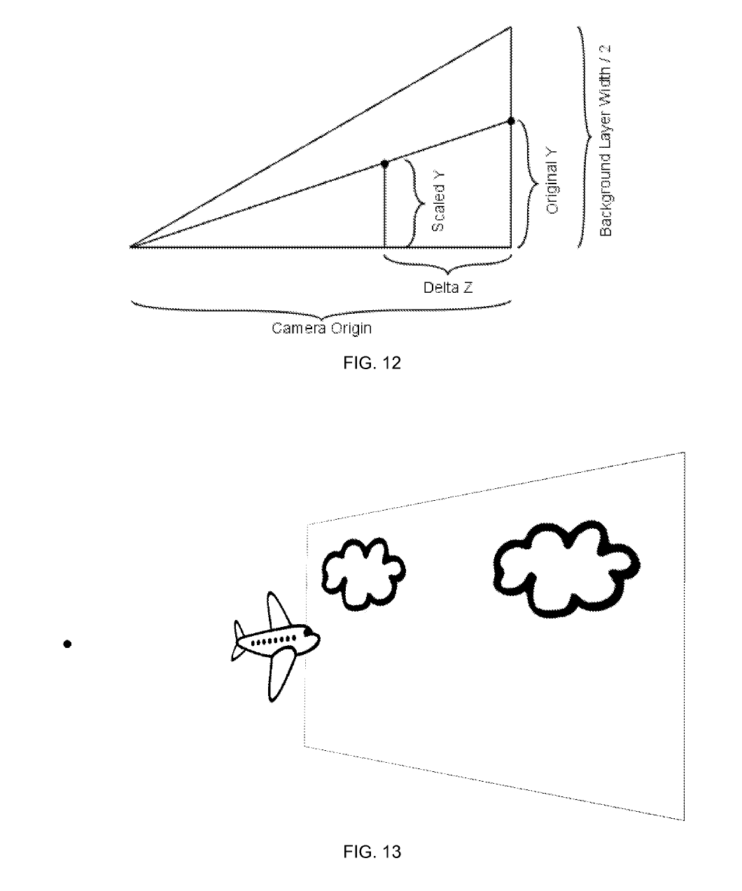

FIG. 12 shows the geometry which is used to determine the scaling rates of y values.

This geometry ensures that throughout the process of depthing each vertex always remains on the line containing its original position and the camera origin. It also ensures geometric consistency since the 3D model will appear identical to the 2D source image when viewed from the camera origin using perspective projection 3D rendering techniques.

FIG. 12 shows a 3D model in which x and y positions of vertices have been scaled to ensure geometric consistency with the 2D source image. Notice that the airplane has become smaller by an amount proportional to the distance that its vertices were moved forward. The dot on the left side of the model represents the camera origin, and the 3D model would appear identical to the 2D source image when viewed from the camera origin.

Storing Models

In the present embodiment, 3D models can be stored by writing the necessary information to a compressed data file. The data file contains the details of all the layers in the model, the order that the layers were created, the positions of the vertices, and a description of the regions which were extracted to create each layer.

It is not necessary to store the 2D source image in the data file. An identical model can be later reconstructed by separately loading the 2D source image and the data file, and recreating the layers of the model in order. Images can take up significant amounts of storage space in computer memory, so the separate storing of 3D information and 2D source images is beneficial.

What is claimed is:

1. A method allowing the user of a software program to create a 3D model from a 2D source image, comprising:
providing a 3D environment to contain the model,
placing the 2D source image within the 3D environment as a layer,
providing extraction tools which allow the user to extract regions of existing layers onto additional layers,
providing depthing tools which allow the user to change the depth of one or more vertices within the layers.

2. The method of claim 1, wherein depthing tools ensure geometric consistency between the 3D model and the 2D source image.

3. The method of claim 2, wherein the manner in which depthing tools ensure geometric consistency between the 3D model and the 2D source image comprises scaling the x and y positions of each vertex such that its resulting position lies on the line containing its original position and the camera origin.

4. The method of claim 1, wherein the extraction tools allow the user to select various regions of the image using a pointing device and virtual paint brush.

5. The method of claim 1, wherein the extraction tools allow the user to select various regions of the image using object recognition techniques.

6. The method of claim 1, wherein the area from which an extraction region of pixels was removed is automatically replaced with a pattern generated based on the pixel colors of the region adjacent to the extraction region.

7. The method of claim 1, wherein the area from which an extraction region of pixels was removed is made transparent.

8. The method of claim 1, wherein the depthing tools allow the user to change the depth of one or more vertices in a layer by the same amount, calculated based on a user-specified delta value.

9. The method of claim 1, wherein the depthing tools allow the user to change the depth of one or more vertices in a layer by different amounts, calculated based on their positions relative to a plurality of user-specified pivot points and also based on a user-specified delta value.

10. The method of claim 1, wherein the depthing tools allow the user to change the depth of one or more vertices in a layer by different amounts, calculated based on their positions relative to a user-specified stretch brush and also based on a user-specified delta value.

11. A method of recreating a 3D model which was previously created from a 2D source image, comprising:
obtaining the 2D source image,
obtaining a data file containing the 3D model information,
recreating the layers of the model in order.
